(19) United States
(12) Patent Application Publication
(10) Pub. No.: US 2024/0367041 A1
(43) Pub. Date: Nov. 7, 2024

(54) INFORMATION PROMPT METHOD AND APPARATUS IN VIRTUAL SCENE, ELECTRONIC DEVICE, STORAGE MEDIUM, AND PROGRAM PRODUCT

(71) Applicant: Tencent Technology (Shenzhen) Company Limited, Shenzhen (CN)

(72) Inventor: Huifei BAO, Shenzhen (CN)

(73) Assignee: Tencent Technology (Shenzhen) Company Limited, Shenzhen (CN)

(21) Appl. No.: 18/776,974

(22) Filed: Jul. 18, 2024

Related U.S. Application Data
(63) Continuation of application No. PCT/CN2023/098977, filed on Jun. 7, 2023.

(30) Foreign Application Priority Data
Aug. 18, 2022 (CN) 202210991597.5

(51) Int. Cl. A63F 13/52; A63F 13/822; G06F 3/14

(52) U.S. Cl. CPC A63F 13/52; G06F 3/14; A63F 13/822

(57) ABSTRACT

In an information prompt method, a virtual scene interface comprising at least two display regions is displayed. Each region is configured to display a different type of prompt information. A number of the at least two display regions is based on a number of types of prompt information. A first prompt information is displayed in a first display region of the at least two display regions corresponding to a first type of prompt information. The second prompt information is displayed in a second display region of the at least two display regions corresponding to a second type of prompt information when a display time point of a second prompt information reaches a preset threshold.

### RELATED APPLICATIONS

The present application is a continuation of International Application No. PCT/CN2023/098977, filed on Jun. 7, 2023, which claims priority to Chinese Patent Application No. 202210991597.5 filed on Aug. 18, 2022. The entire disclosures of the prior applications are hereby incorporated by reference.

### FIELD OF THE TECHNOLOGY

This disclosure relates to human-computer interaction technologies, including to an information prompt method and apparatus in a virtual scene, an electronic device, a storage medium, and a program product.

### BACKGROUND OF THE DISCLOSURE

Human-computer interaction technologies for virtual scenes based on graphics processing hardware may implement diversified interactions between virtual objects controlled by users or artificial intelligence, and have broad practical values. For example, in virtual scene applications such as video games, a real battle process between virtual objects may be simulated. Taking a shooting game as an example, virtual objects in different groups battle in the game.

In a virtual scene, there are multiple types of prompt information to prompt a player in interaction in the virtual scene. When multiple types of prompt information need to be displayed, in related technologies, the multiple types of prompt information are either simultaneously displayed at the same position in an interface, or displayed one by one. However, in the former case, information overlay results in poor readability of the prompt information. In the latter case, the prompt information is displayed one by one, and the display of a part of prompt information is untimely, making the prompt efficiency low.

### SUMMARY

This disclosure provides an information prompt method and apparatus in a virtual scene, an electronic device, a non-transitory computer-readable storage medium, and a computer program product, which can improve readability and prompt efficiency of prompt information.

An aspect of this disclosure provides an information prompt method in a virtual scene. In the method, a virtual scene interface comprising at least two display regions is displayed. Each region is configured to display a different type of prompt information. A number of the at least two display regions is based on a number of types of prompt information. A first prompt information is displayed in a first display region of the at least two display regions corresponding to a first type of prompt information. The second prompt information is displayed in a second display region of the at least two display regions corresponding to a second type of prompt information when a display time point of a second prompt information reaches a preset threshold.

An aspect of this disclosure provides an information prompt apparatus in a virtual scene, including processing circuitry is provided. The processing circuitry is configured to display a virtual scene interface comprising at least two display regions. Each region is configured to display a different type of prompt information. A number of the at least two display regions is based on a number of types of prompt information. The processing circuitry is configured to display a first prompt information in a first display region of the at least two regions corresponding to a first type of prompt information. The processing circuitry is configured to display the second prompt information in a second display region of the at least two display regions corresponding to a second type of prompt information when a display time point of a second prompt information reaches a preset threshold.

An aspect of this disclosure provides a terminal device, including:
a memory, configured to store an executable instruction; and
a processor, configured to execute the executable instruction stored in the memory, to perform the information prompt method in a virtual scene according to the examples of this disclosure.

An aspect of this disclosure provides a non-transitory computer-readable storage medium, storing instructions which when executed by a processor cause the processor to perform the information prompt method in a virtual scene according to the aspects of this disclosure.

An aspect of this disclosure provides a computer program product, including a computer program or instruction, the computer program or instruction being executed by a processor to implement the information prompt method in a virtual scene according to the aspects of this disclosure.

In an example of this disclosure, the virtual scene interface includes multiple display regions, and different display regions are configured for displaying different types of prompt information. For example, the first prompt information of the first type is displayed in the first display region, and the second prompt information of the second type is displayed in the second display region. In this way, different types of prompt information are displayed separately in the corresponding display regions, which avoids information overlay and improves readability of the prompt information. Besides, different types of prompt information can be simultaneously displayed in the corresponding display regions, improving the information prompt efficiency. In addition, when the second prompt information of the second type exists in the virtual scene, that is, when there is the second prompt information that needs to be displayed, where the second prompt information is associated with the first prompt information, the second prompt information is displayed in the second display region when the display time point of the second prompt information reaches, so that the display timeliness of the second prompt information is ensured and the utilization of display resources is improved.

### BRIEF DESCRIPTION OF THE DRAWINGS

FIG. 1A and FIG. 1B are schematic diagrams of display of prompt information in a virtual scene according to aspects of this disclosure;

FIG. 2A is a schematic diagram of an application mode of an information prompt method in a virtual scene according to an aspect of this disclosure;

FIG. 2B is a schematic diagram of an application mode of an information prompt method in a virtual scene according to an aspect of this disclosure;

FIG. 3 is a schematic structural diagram of a terminal device 400 according to an aspect of this disclosure;

FIG. 4 is a schematic flowchart of an information prompt method in a virtual scene according to an aspect of this disclosure;

FIG. 5 is a schematic diagram of display region division according to an aspect of this disclosure;

FIG. 6 is a schematic diagram of display region division according to an aspect of this disclosure;

FIG. 7 is a schematic diagram of display control of prompt information according to an aspect of this disclosure;

FIG. 8 is a schematic diagram of display control of prompt information according to an aspect of this disclosure;

FIG. 9 is a schematic diagram of display control of prompt information according to an aspect of this disclosure;

FIG. 10 is a schematic diagram of display control of prompt information according to an aspect of this disclosure; and

FIG. 11 is a schematic flowchart of an information prompt method in a virtual scene according to an aspect of this disclosure.

### DETAILED DESCRIPTION

To make the objectives, technical solutions, and advantages of this disclosure clearer, the following describes this disclosure in further detail with reference to the accompanying drawings. The described examples are not to be considered as a limitation to this disclosure. Other examples shall fall within the protection scope of this disclosure.

In the following description, the term “first/second/ . . . ” is only used to distinguish similar objects and does not represent a specific sequence of objects. “First/second/ . . . ” can be interchanged if allowed, so that the disclosure described herein can be implemented in a sequence other than that illustrated or described. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Unless otherwise defined, meanings of all technical and scientific terms used in this specification are the same as those usually understood by a person skilled in the art to which this disclosure belongs. The examples of terms used herein are only for the purpose of describing examples of this disclosure and are not intended to limit this disclosure.

Before the examples of this disclosure are further described in detail, examples of nouns and terms used in the examples of this disclosure is provided.
(1) Client, that is, application programs running in terminals to provide various services, such as video playing clients and game clients.
(2) In response to: used to indicate a condition or a state on which an operation to be executed depends. When the condition or state on which an operation to be executed depends is satisfied, one or more operations to be executed may be performed in real time or with a specified delay. Unless otherwise specified, there is no restriction on the sequence in which multiple operations to be executed are performed.
(3) Virtual scene, that is, a virtual scene displayed (or provided) when an application program runs on a terminal. The virtual scene may be a simulation environment of the real world, a semi-simulation and semi-fictitious virtual environment, or a purely fictitious virtual environment. The virtual scene may be any one of a two-dimensional virtual scene, a 2.5-dimensional virtual scene, or a three-dimensional virtual scene. The examples of this disclosure do not limit the dimension of the virtual scene. For example, the virtual scene may include sky, land, and ocean. The land may include environmental elements such as deserts and cities, and a user may control a virtual object to move in the virtual scene.
(4) Virtual object, that is, characters of various persons and objects that may interact in a virtual scene, or movable objects in a virtual scene. The movable object may be a virtual person, a virtual animal, an animation person, or the like, such as a person or an animal displayed in a virtual scene. The virtual object may be a virtual character for representing a user in the virtual scene. The virtual scene may include multiple (that is, at least two) virtual objects, and each virtual object has a shape and a volume in the virtual scene, and occupies some space in the virtual scene. A virtual object may be a game character controlled by a user (or referred to as a player), that is, the virtual object is controlled by a real user and moves in the virtual scene in response to an operation performed on a controller (including a touch screen, a voice-activated switch, a keyboard, a mouse, and a joystick) by the real user. For example, when the real user moves the joystick to the left, the virtual object moves to the left in the virtual scene, and may also stay still, jump, and use various functions (for example, skills and props).

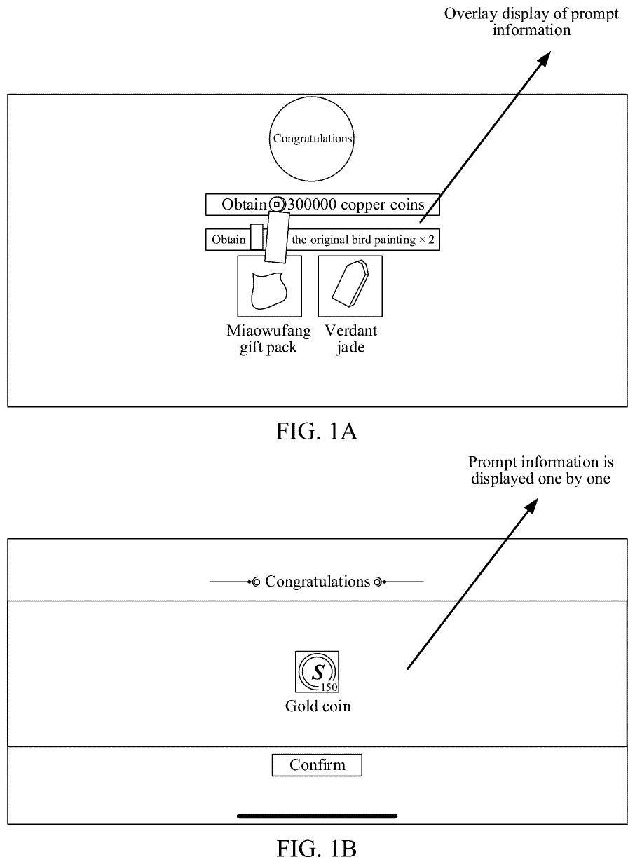

FIG. 1A and FIG. 1B are schematic diagrams of display of prompt information in a virtual scene according to examples of this disclosure. The inventor found that when different types of prompt information need to be displayed, the different types of prompt information are displayed at the same position in FIG. 1A. In this manner, multiple types of prompt information are overlaid in a game interface, resulting in poor readability of the prompt information. In FIG. 1B, pieces of prompt information are displayed one by one at the same position, that is, after one piece of prompt information is displayed, another piece of prompt information is displayed. In this manner, a waiting time of prompt information is long, resulting in display untimeliness of a part of prompt information and low prompt efficiency.

To this end, the examples of this disclosure provide an information prompt method and apparatus in a virtual scene, an electronic device, a computer-readable storage medium, and a computer program product, which can improve readability and prompt efficiency of prompt information. For case of understanding the information prompt method in a virtual scene provided by the examples of this disclosure, a description of an example implementation is provided. The virtual scene in the information prompt method in a virtual scene provided by the examples of this disclosure may be outputted completely based on a terminal device, or based on the collaboration of a terminal device and a server. The virtual scene may be an environment for game characters to interact, for example, may be used for a game character to battle. By controlling an action of the game character, two parties may interact in the virtual scene, thus enabling users to relieve life stress during the game.

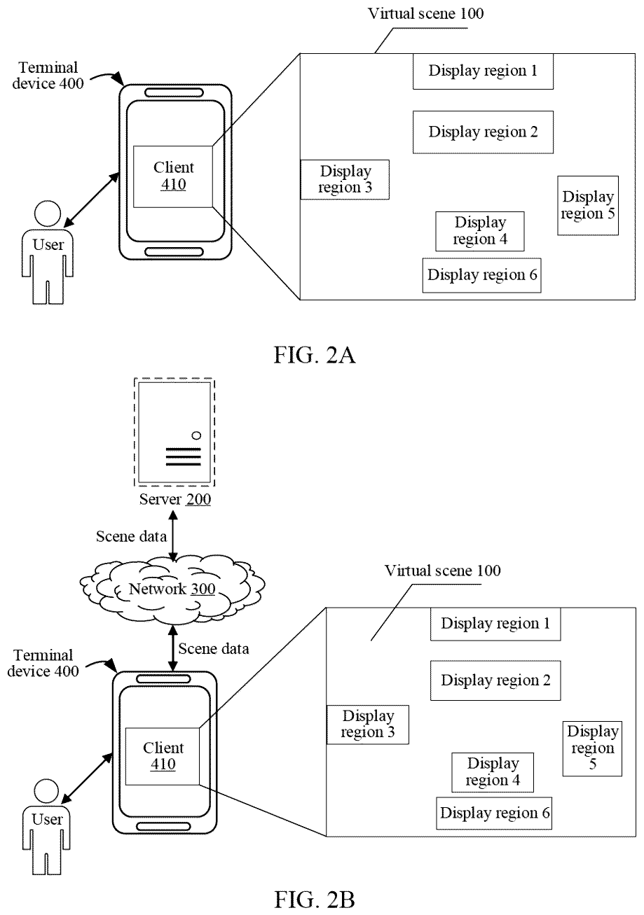

In an implementation scenario, refer to FIG. 2A. FIG. 2A is a schematic diagram of an application mode of an information prompt method in a virtual scene according to an aspect of this disclosure. The method is suitable for some application modes in which related data of a virtual scene 100 may be calculated completely based on computing power of graphics processing hardware of a terminal device 400, such as stand-alone/offline-mode games. The virtual scene may be outputted through various different types of terminal devices 400 such as smartphones, tablet computers, and virtual reality/augmented reality devices. For example, a type of the graphics processing hardware includes a central processing unit (CPU) and a graphics processing unit (GPU).

When forming visual perception of the virtual scene 100, the terminal device 400 calculates, through the graphics computing hardware, data required for display, completes loading, parsing, and rendering of the display data, and outputs, through graphics output hardware, video frames capable of forming visual perception of the virtual scene, for example, presents two-dimensional video frames on a display screen of a smartphone, or projects video frames on lenses of augmented reality/virtual reality glasses to achieve a three-dimensional display effect. In addition, to enrich the perception effect, the terminal device 400 may also use different hardware to form one or more of auditory perception, tactile perception, motion perception, and taste perception.

As an example, the terminal device 400 runs a client 410 (for example, a stand-alone game application). In the running process of the client 410, the virtual scene 100 including role-playing is outputted. The virtual scene 100 may be an environment for virtual objects (game characters) to interact, for example, may be plains, streets, and valleys for game characters to battle. The virtual scene 100 may further include prompt information (displayed in a display region) to prompt the virtual object in interaction in the virtual scene, for example, prompt at an appropriate location and timing what the virtual object can and cannot do, feedback after some operations are performed, and how to solve problems when encountering them.

As an example, the terminal device displays a virtual scene interface including at least two display regions, different display regions being configured for displaying different types of prompt information; displays, in response to a display instruction for first prompt information of a first type, the first prompt information in a first display region corresponding to the first type; and in a process of displaying the first prompt information, displays, in response to that second prompt information of a second type exists in the virtual scene and a display time point of the second prompt information reaches or a time distance from the display time point reaches a preset threshold, the second prompt information in a second display region corresponding to the second type. In this way, in the process of displaying the first prompt information of the first type in the first display region, when the second prompt information of the second type needs to be displayed, the second prompt information is displayed in the second display region if the display time point of the second prompt information reaches, to ensure display timeliness of the second prompt information. Besides, different types of prompt information can be simultaneously displayed in different display regions independently, avoiding information overlay and improving readability and prompt efficiency of prompt information.

In another implementation scenario, refer to FIG. 2B. FIG. 2B is a schematic diagram of an application mode of an information prompt method in a virtual scene according to an aspect of this disclosure. The method is applied to the terminal device 400 and the server 200 and is suitable for an application mode in which the computing power of the server 200 performs virtual scene calculation and the terminal device 400 outputs the virtual scene. Taking formation of visual perception of the virtual scene 100 as an example, the server 200 calculates related display data (such as scene data) of the virtual scene and sends the data to the terminal device 400 through a network 300. The terminal device 400 completes loading, parsing, and rendering of the calculated display data through graphics computing hardware, and outputs the virtual scene through graphics output hardware to form visual perception, for example, may present two-dimensional video frames on the display screen of a smartphone, or project video frames on lenses of augmented reality/virtual reality glasses to achieve a three-dimensional display effect. For the perception of the form of the virtual scene, corresponding hardware output of the terminal device 400 may be used, for example, a microphone is used to form auditory perception, or a vibrator is used to form tactile perception.

As an example, the terminal device 400 runs a client 410 (for example, a stand-alone game application). In the running process of the client 410, the virtual scene 100 including role-playing is outputted. The virtual scene 100 may be an environment for game characters to interact, for example, may be plains, streets, and valleys for game characters to battle. The virtual scene 100 may further include prompt information to prompt the virtual object in interaction in the virtual scene, for example, prompt at an appropriate location and timing what the virtual object can and cannot do, feedback after some operations performed, and how to solve problems when encountering them.

As an example, the terminal device displays a virtual scene interface including at least two display regions, different display regions being configured for displaying different types of prompt information; displays, in response to a display instruction for first prompt information of a first type, the first prompt information in a first display region corresponding to the first type; and in a process of displaying the first prompt information, displays, in response to that second prompt information of a second type exists in the virtual scene and the second prompt information is associated with the first prompt information and when a display time point of the second prompt information reaches, the second prompt information in a second display region corresponding to the second type. In this way, in the process of displaying the first prompt information of the first type in the first display region, during display of the second prompt information of the second type, the second prompt information is displayed in the second display region if the display time point of the second prompt information reaches, to ensure display timeliness of the second prompt information. Besides, different types of prompt information can be simultaneously displayed in different display regions independently, avoiding information overlay and improving readability and prompt efficiency of prompt information.

For example, the terminal device 400 may also implement, by running a computer program, the information prompt method in a virtual scene provided by this disclosure. For example, the computer program may be a native program or software module in an operating system, may be a native application (APP), that is, a program that needs to be installed in the operating system to run, such as a shooting game APP (that is, the client 410), may be a mini program, that is, a program that only needs to be downloaded to a browser environment to run; or may be a game mini application that may be embedded in any APP. In conclusion, the computer program may be any form of application, module, or plug-in.

Taking a computer program as an application program as an example, during actual implementation, the terminal device 400 installs and runs an application program that supports virtual scenes. The application program may be any one of a first-person shooting game (FPS), a third-person shooting game, a virtual reality application program, a three-dimensional map program, a simulation program, or a multiplayer gun battle survival game. A user uses the terminal device 400 to operate a virtual object in the virtual scene to perform activities. The activities include but are not limited to: at least one of adjusting the body posture, crawling, walking, running, riding, jumping, driving, picking up, shooting, attacking, throwing, and building a virtual architecture. Illustratively, the virtual object may be a virtual character, such as a simulated character or an animation character.

An aspect of this disclosure may also be implemented with the help of a cloud technology. The cloud technology refers to a hosting technology that combines a series of resources such as hardware, software, and networks in a wide area network or a local area network to perform data calculation, storage, processing, and sharing. The cloud technology is a general term for a network technology, an information technology, an integration technology, a management platform technology, an application technology, and the like applied based on the business mode of cloud computing, and may form a resource pool used on demand flexibly and conveniently. The cloud computing technology will become an important support. The background services of technical network systems require a large amount of computing and storage resources.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

For example, the server 200 in FIG. 2B may be an independent physical server, or a server cluster including multiple physical servers or a distributed system, or may be a cloud server that provides basic cloud computing services such as cloud services, cloud databases, cloud computing, cloud functions, cloud storage, and network services, cloud communications, middleware services, domain name services, security services, content delivery networks (CDN), big data, and artificial intelligence platforms. The terminal device 400 may be a smartphone, a tablet computer, a notebook computer, a desktop computer, a smart speaker, a smartwatch, or the like, but is not limited thereto. The terminal device 400 and the server 200 may be connected directly or indirectly through wired or wireless communication, which is not limited in this disclosure.

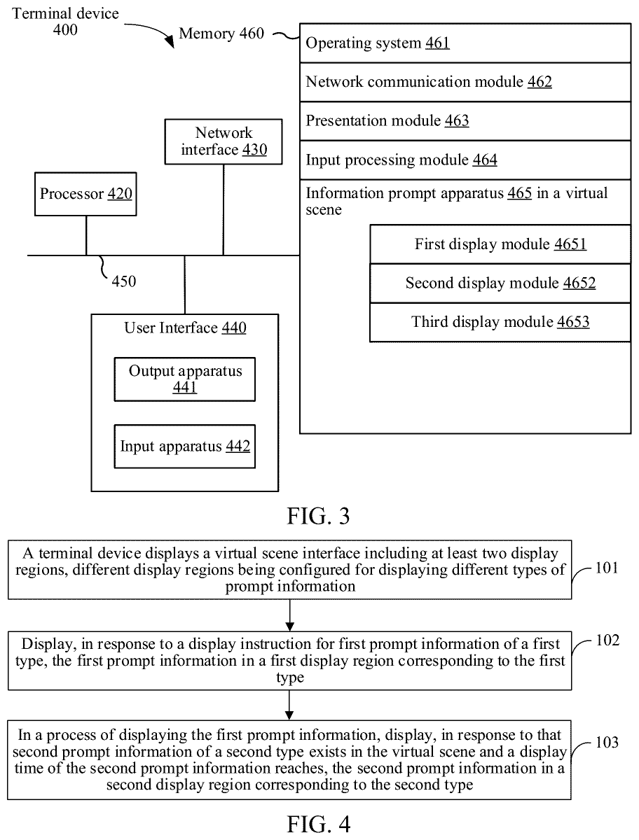

The following describes an electronic device that implements the information prompt method in a virtual scene according to the examples of this disclosure. The electronic device may be a terminal device or a server. For example, the electronic device is the terminal device 400 shown in FIG. 2A. The structure of the terminal device 400 shown in FIG. 2A is described. FIG. 3 is a schematic structural diagram of a terminal device 400 according to an aspect of this disclosure. As shown in FIG. 3, the terminal device 400 includes: at least one processor 420, a memory 460, at least one network interface 430, and a user interface 440. The components in the terminal device 400 are coupled together through a bus system 450. The bus system 450 is configured to implement connection and communication between the components. In addition to a data bus, the bus system 450 further includes a power bus, a control bus, and a state signal bus, but, for ease of clear description, all types of buses in FIG. 3 are marked as the bus system 450.

Processing circuitry, such as the processor 420 may be an integrated circuit chip with signal processing capabilities, such as a general-purpose processor, a digital signal processor (DSP), or other programmable logic devices, discrete gate or transistor logic devices, and discrete hardware components. The general-purpose processor may be a microprocessor or any conventional processor.

The user interface 440 includes one or more output apparatuses 441 that enable the presentation of media content, such as a speaker for outputting audio and a visual display for outputting pictures. The user interface 440 further includes one or more input apparatuses 442, and includes user interface components that facilitate user input, such as a keyboard, a mouse, a microphone, a touch display screen, a camera, and other input buttons and controls.

The memory 460 may be a removable memory, a non-removable memory, or a combination thereof. For example, hardware devices include solid-state memories, hard disk drives, optical disk drives, and the like. In an example, the memory 460 may include one or more storage devices physically located away from the processor 420.

The memory 460, such as a non-transitory computer-readable storage medium, may be a volatile memory or a non-volatile memory, or may include both a volatile memory and a non-volatile memory. The non-volatile memory may be a read-only memory (ROM), and the volatile memory may be a random access memory (RAM). The memory 460 described in this example of this disclosure aims to include any suitable type of memory.

In an example, the memory 460 may store data to support various operations, and examples of the data include programs, modules, data structures, or subsets or supersets thereof, as an example described below. An operating system 461 includes system programs for processing various basic system services and executing hardware-related tasks, such as a framework layer, a core library layer, and a driver layer, to implement various basic services and process hardware-based tasks. The network communication module 462 is configured to reach other computing devices through one or more (wired or wireless) network interfaces 430. For example, the network interface 430 includes: Bluetooth, Wi-Fi, a universal serial bus (USB), and the like. A presentation module 463 is configured to display information through one or more output apparatuses 441 (for example, display screens or speakers) associated with the user interface 440 (for example, is configured to operate a peripheral device and a user interface that displays content and information). An input processing module 464 is configured to detect one or more user inputs or interactions from one or more input apparatuses 442, and translate the detected inputs or interactions.

In an example, the information prompt apparatus in a virtual scene provided by the aspects of this disclosure may be implemented by software. FIG. 3 shows an information prompt apparatus 465 in a virtual scene stored in the memory 460. The apparatus may be software in a form of program and plug-in and includes the following software modules: a first display module 4651, a second display module 4652, and a third display module 4653. These modules are logical and therefore may be combined or split in different manners according to functions implemented. Functions of each module will be described below.

In an example, the information prompt apparatus in a virtual scene may be implemented by hardware. As an example, the information prompt apparatus in a virtual scene may be a processor in the form of a hardware decoding processor, which is programmed to execute the information prompt method in a virtual scene. For example, the processor in the form of a hardware decoding processor may be one or more application specific integrated circuits (ASIC), DSPs, programmable logic devices (PLD), complex programmable logic devices (CPLD), field programmable gate arrays (FPGA), or other electronic components.

The information prompt method in a virtual scene is described below with reference to accompanying drawings. The information prompt method in a virtual scene may be executed only by the terminal device 400 in FIG. 2A, or may be executed collaboratively by the terminal device 400 and the server 200 in FIG. 2B. In the following, for example, only the terminal device 400 in FIG. 2A executes the information prompt method in a virtual scene. FIG. 4 is a schematic flowchart of an information prompt method in a virtual scene. Operations shown in FIG. 4 will be described.

The method shown in FIG. 4 may be executed by various forms of computer programs running on the terminal device 400, and is not limited to be executed by the client 410, for example, may also be executed by the operating system 461, software modules, and scripts. Therefore, the client is not considered as limiting this disclosure.

Operation 101: A terminal device displays a virtual scene interface including at least two display regions, different display regions being configured for displaying different types of prompt information.

The terminal device is installed with a client that supports a virtual scene. The client may be a dedicated client for a virtual scene. For example, when the virtual scene is a game, the corresponding client may be a shooting game APP. The client may also be a client with a virtual scene function, such as an instant messaging client or a media information playback client. When a user opens a client installed on the terminal device and the terminal device runs the client, the client may display a virtual scene interface. A variety of information related to the virtual scene may be displayed in the interface, such as an image of the virtual scene observed from the perspective of a target virtual object (a virtual object of a current login account in the virtual scene), or prompt information pushed as the virtual scene progresses.

Herein, the prompt information may carry an information identifier. The information identifier is configured for identifying a type of corresponding prompt information. The type of prompt information may be preset. For example, the type of prompt information may include: an announcement type, an interactive prompt type, a system type, a gameplay prompt type, and the like.

The prompt information may include at least one of the following elements: sound, text, color, graphics, somatosense, and time. The prompt information may be configured for prompting a target virtual object in interaction in the virtual scene, for example, prompt at an appropriate location and timing what the target virtual object can and cannot do, feedback after some operations performed, what problems will be encountered, and how to solve problems. The types of prompt information may include various types, such as prompt information of interaction between virtual objects, announcements, system or gameplay prompt information, shortcut key usage prompt information, dialog prompt information, and the like. To provide players with highly readable prompt information in a proper layout, the virtual scene interface may be divided into multiple display regions, and each display region is configured for displaying one type of prompt information.

For example, before the terminal device displays the virtual scene interface including at least two display regions, the terminal device may divide the region of the virtual scene interface in the following manner: when a number of types of prompt information in a virtual scene is a target number, dividing the virtual scene interface into the target number of display regions, where each display region corresponds to one type of prompt information; and according to distribution of each display region and an attribute characteristic of each type of prompt information, establishing a correspondence between each display region and a corresponding type of prompt information.

Herein, when dividing the virtual scene interface, the interface may be divided (either uniformly or non-uniformly) into a corresponding number of display regions according to the number of types of prompt information. For example, assuming that there are 5 types of prompt information in the virtual scene, the interface is divided into 5 display regions. In addition, a correspondence between each display region and a type of prompt information may also be established based on the attribute characteristic of each type of prompt information (for example, an appearance frequency, a number, importance, whether there is interaction, and an information length) and the layout of each divided display region (for example, a location and a size), so that the prompt information displayed in each display region is highly readable and the prompt information is effective.

For example, according to the importance, the appearance frequency, and the information length in the attribute characteristic of the prompt information, the display region of the virtual scene is divided into regions corresponding to the following types of prompt information: important prompt information, high-appearance-frequency prompt information, and multi-prompt-content prompt information. For example, if prompt information of the first type is very important (that is, important prompt information), a correspondence between the prompt information of the first type and an eye-catching first display region in the interface is established, that is, very important prompt information is displayed in the eye-catching region, which improves the readability of important prompt and is conducive to the effective communication of important prompt information. For another example, if prompt information of the second type appears frequently (that is, high-appearance-frequency prompt information), a correspondence between the prompt information of the second type and the second display region at the edge of the interface is established, that is, high-appearance-frequency prompt information is displayed in the edge region that does not block the line of sight of the player, which can not only effectively convey the prompt information, but also avoid excessive interference to the player. For another example, if prompt information of the third type is long (which has more prompt content, that is, multi-prompt-content prompt information), and the size of a third display region is large, a correspondence between prompt information of the third type and the third display region is established. The prompt information with more content may be fully displayed in a large region, which can improve the readability of the prompt information and is conducive to the effective communication of the prompt information.

Herein, important prompt information is configured for indicating that the importance of this type of prompt information is relatively high. It can be known in multiple manners whether the prompt information is of an important type. If the prompt information carries an importance label, it is determined that the prompt information is important prompt information. High-appearance-frequency prompt information is configured for indicating that the appearance frequency of this type of prompt information is higher than an appearance frequency threshold (which may be set according to actual needs). For example, when the prompt information is obtained, a number of times the prompt information appears in a unit time (which may be set according to actual needs, such as 10 minutes) is counted. When the number of times the prompt information appears in the unit time reaches the appearance frequency threshold, it is determined that the prompt information is high-appearance-frequency prompt information. Multi-prompt-content prompt information is configured for indicating that this type of prompt information has more prompt content, that is, the information length is long. After the prompt information is obtained, the size of the display region required to display the prompt information may be calculated, and when it is determined that the required size of the display region reaches a display region threshold, it is determined that the prompt information is multi-prompt-content prompt information.

Operation 102: Display, in response to a display instruction for first prompt information of a first type, the first prompt information in a first display region corresponding to the first type.

Herein, when receiving a display instruction for the first prompt information of the first type, in response to the display instruction, the terminal device first determines the first display region corresponding to the first type, so as to display the first prompt information in the first display region. The first prompt information may be displayed in the first display region in multiple manners, including but not limited to: bubble, pop-up, table, and the like.

Operation 103: In a process of displaying the first prompt information, display, in response to that second prompt information of a second type exists in the virtual scene and a display time of the second prompt information reaches, the second prompt information in a second display region corresponding to the second type.

Herein, the display time of the second prompt information reaches may be that the display time point of the second prompt information reaches or the time distance from the display time point reaches a preset threshold.

For example, in a process of displaying the first prompt information, in response to that second prompt information of a second type exists in the virtual scene and the second prompt information is associated with the first prompt information and when a display time point of the second prompt information reaches, the second prompt information is displayed in a second display region corresponding to the second type.

Herein, the association is described. The association may be an inheritance relationship, a causal relationship, or a time domain relationship. The inheritance relationship is configured for indicating that there is an inheritance relationship between the second prompt information and the first prompt information. For example, the second prompt information is derived from the first prompt information, or there is correlation between the contents of the second prompt information and the first prompt information. The causal relationship is configured for indicating a causal relationship between the existence of the second prompt information and the first prompt information. For example, the second prompt information exists only when the first prompt information is generated first. The time domain relationship is configured for indicating that there is a time domain relationship between the second prompt information and the first prompt information. For example, the interval between the generation time points of the information is less than a preset threshold.

This association may be configured for indicating the display timing of the second prompt information, and the display timing includes at least one of the following: the display time point of the second prompt information and a threshold of the time distance from the display time point.

Normally, when the terminal device controls the display of different types of prompt information in different display regions, if the prompt information of all these types is independent of each other, the display in each display region is also controlled independently, that is, corresponding types of prompt information are displayed in different display regions without interference from each other, and each piece of prompt information of a corresponding type is displayed according to respective display logic. If different types of prompt information are associated (for example, the inheritance relationship and the causal relationship), the terminal device needs to coordinately control the corresponding display regions.

For example, in the process of displaying the first prompt information, the terminal device obtains the running progress of the virtual scene and the display progress of the first prompt information; and generates the second prompt information according to the running progress and the display progress, and establishes an association between the first prompt information and the second prompt information.

Herein, under normal circumstances, the generation of one piece of prompt information among different pieces of prompt information that are associated is related to the running progress of the virtual scene and the display progress of another piece of prompt information. For example, when a level of the target virtual object is a level 1, the first prompt information is displayed in the first display region. As the level of the target virtual object gradually increases, for example, increases to a level 2, the terminal device derives the second prompt information of the second type based on the first prompt information, and establishes association between the first prompt information and the second prompt information. In this way, in the process of displaying the first prompt information in the first display region, the terminal device determines, according to the display progress of the first prompt information, whether second prompt information of the second type associated with the first prompt information exists in the virtual scene, for example, determines whether the second prompt information of the second type generated based on the display progress of the first prompt information exists (in this case, the second prompt information may be considered as information derived from the first prompt information, and the two pieces of information have an inheritance relationship). If the second prompt information of the second type generated based on the display progress of the first prompt information exists, it is determined that the second prompt information of the second type associated with the first prompt information exists. When it is determined that the second prompt information exists, it is then determined, based on the correlation between the two pieces of information, whether the display timing of the second prompt information reaches. When it is determined that the display timing of the second prompt information reaches, the second display region corresponding to the second type is obtained, and the second prompt information is displayed in the second display region.

For example, before the terminal device displays the second prompt information in the second display region corresponding to the second type, when the association indicates that the display progress of the first prompt information reaches the target progress, the terminal device starts to display the second prompt information, and in the process of displaying the first prompt information, detects the display progress of the first prompt information. When the display progress of the first prompt information reaches the target progress, the terminal device determines that the display timing of the second prompt information reaches.

Herein, for the first prompt information and the second prompt information that are associated, the association is configured for indicating the display timing of the second prompt information (that is, relative to the display progress of the first prompt information, a time at which the second prompt information is displayed). If the association indicates that the second prompt information starts to be displayed when the first prompt information is displayed to the 5^{th} second, the terminal device detects, in the process of displaying the first prompt information, in real time whether the first prompt information has been displayed to the 5^{th} second, and when determining that content of the 5^{th} second of the first prompt information has been displayed, may determine that the display timing of the second prompt information reaches, and display the second prompt information in the second display region.

In the above manner, different types of prompt information are displayed separately in corresponding display regions. Since the display regions are independent of each other, information overlay is avoided and the readability of the prompt information is improved. Besides, different types of prompt information may be displayed in the corresponding display regions simultaneously, thereby improving the information prompt efficiency. In addition, the terminal device has established an association for different types of prompt information in different display regions. In the process of displaying one type of prompt information, when the display timing of another type of prompt information reaches, the another type of prompt information is immediately displayed in the corresponding display region, thereby ensuring the display timeliness of prompt information and improving user experience.

For example, in response to the second prompt information not being associated with the first prompt information, the terminal device detects whether third prompt information of the second type is displayed in the second display region; and in response to the third prompt information not being displayed in the second display region, displays the second prompt information in the second display region.

For example, when the second prompt information is not associated with the first prompt information, a display priority of the second prompt information is considered to be lower than a display priority of prompt information currently displayed in the second display region. When the third prompt information is displayed in the second display region, the second prompt information is not displayed temporarily, and when display of the third prompt information is completed in the second display region, the second prompt information is displayed in the second display region.

Since the terminal device maintains an information queue in each display region, and there is at least one piece of to-be-displayed prompt information in the information queue, the terminal device sequentially displays prompt information in this display region in descending order of display priorities of prompt information in the information queue.

When determining that the second prompt information is not associated with the first prompt information, the terminal device detects whether other prompt information (for example, the third prompt information) of the second type is being displayed in the second display region. When the detection result represents that the third prompt information is currently not displayed in the second display region, the second prompt information may be displayed in the second display region. In this way, while the first prompt information is displayed in the first display region, the second prompt information is displayed in the second display region. The two pieces of information are displayed independently, which avoids information overlay and improves the readability of prompt information and information prompt efficiency.

For example, in response to the third prompt information being displayed in the second display region, in the process of displaying the third prompt information, the terminal device displays the second prompt information in the second display region. Display positions of the second prompt information and the third prompt information in the second display region are different.

Herein, when the terminal device determines that the second prompt information is not associated with the first prompt information and the third prompt information is currently being displayed in the second display region, the second prompt information is displayed in a display position of the second display region other than a display position of the third prompt information. In this way, while the first prompt information is displayed in the first display region, the second prompt information and the third prompt information are simultaneously displayed in the second display region. Because the display positions of the second prompt information and the third prompt information in the second display region are different, this avoids information overlay and improves the readability of prompt information and information prompt efficiency.

For example, in response to the third prompt information being displayed in the second display region, the terminal device stores the second prompt information in an information queue corresponding to the second display region, where at least one piece of fourth prompt information is also stored in the information queue; obtains prompt priorities corresponding to the second prompt information and the at least one piece of fourth prompt information respectively, and sorts the second prompt information and the at least one piece of fourth prompt information in descending order of the prompt priorities; and in response to display of the third prompt information being completed, displays, in the second display region, prompt information sorted in front in the information queue.

Herein, when the terminal device determines that the second prompt information is not associated with the first prompt information and the third prompt information is currently being displayed in the second display region, the second prompt information may be directly placed in the corresponding information queue of the second display region, so that the second prompt information and at least one to-be-displayed other prompt information (for example, the fourth prompt information) are re-sorted in the information queue, for example, in descending order of prompt priorities of the second prompt information and the fourth prompt information. Besides, after display of the third prompt information is completed, the top-sorted prompt information is displayed in the second display region.

For example, the terminal device may determine the prompt priority of the prompt information in the following manner: obtaining priority parameters of the second prompt information and each of at least one piece of fourth prompt information respectively, and determining prompt priorities of the second prompt information and each piece of fourth prompt information based on the prompt priority parameters; where the priority parameter includes at least one of the following: a generation time of generating the prompt information in the virtual scene and a prompt weight set for the prompt information.

Herein, when determining the prompt priority of each piece of prompt information in the information queue, the terminal device determines the prompt priority of the corresponding prompt information based on priority parameters such as the generation time of generating prompt information in the virtual scene and the prompt weight set when generating the prompt information. For example, when a larger prompt weight is set, the corresponding prompt priority is higher, or when the generation time is earlier, the corresponding prompt priority is higher. When at least two pieces of prompt information have the same prompt weight, the prompt priority of each piece of prompt information is determined according to the generation time.

For example, the terminal device may store the second prompt information into the information queue corresponding to the second display region in the following manner: in response to the third prompt information being displayed in the second display region, comparing the prompt priorities of the third prompt information and the second prompt information; and in response to the prompt priority of the third prompt information being higher than the prompt priority of the second prompt information, storing the second prompt information in the information queue corresponding to the second display region.

Herein, when the terminal device determines that the second prompt information is not associated with the first prompt information and the third prompt information is currently being displayed in the second display region, the terminal device may also first compare the prompt priorities of the third prompt information and the second prompt information. When the prompt priority of the third prompt information is lower than the prompt priority of the second prompt information, the terminal sets to stop displaying the third prompt information in the second display region, and displays the second prompt information in the second display region (that is, the third prompt information displayed in the second display region is switched to display the second prompt information), and after display of the second prompt information is completed, continues to display the third prompt information in the second display region. When the prompt priority of the third prompt information is higher than the prompt priority of the second prompt information, the third prompt information continues to be displayed in the second display region, and the second prompt information is stored in the corresponding information queue of the second display region, so that the second prompt information and at least one to-be-displayed fourth prompt information are re-sorted in the information queue, for example, in descending order of prompt priorities of the second prompt information and the fourth prompt information, so that after display of the third prompt information is completed, the top-sorted prompt information is displayed in the second display region.

For example, in the process of displaying the first prompt information, the terminal device displays the fifth prompt information of the second type in the second display region. Correspondingly, the terminal device may display, when determining that the display timing of the second prompt information reaches according to the association, the second prompt information in the second display region corresponding to the second type in the following manner: in the process of displaying the fifth prompt information, when determining that the display timing of the second prompt information reaches according to the association, stopping displaying the fifth prompt information in the second display region and displaying the second prompt information; and in response to display of the second prompt information being completed, continuing to display the fifth prompt information in the second display region.

Herein, in the process of displaying the first prompt information in the first display region, before displaying the second prompt information of the second type in the second display region, if the terminal device displays fifth prompt information of the second type in the second display region, that is, the terminal device displays the first prompt information in the first display region and the fifth prompt information in the second display region at the same time, when receiving the display instruction for the second prompt information associated with the first prompt information (that is, the display timing of the second prompt information reaches), the terminal device stops displaying the fifth prompt information in the second display region, displays the second prompt information in the second display region (that is, the fifth prompt information displayed in the second display region is switched to display the second prompt information), and after display of the second prompt information is completed, continues to display the fifth prompt information in the second display region. In this way, an association between the first prompt information and the second prompt information is established, and the display priority of the second prompt information is set to the highest, thereby improving the information prompt timeliness and flexibility.

For example, in the process of displaying the first prompt information, the terminal device displays the sixth prompt information of the second type in a first sub-region of the second display region. Correspondingly, the terminal device may display, when determining that the display timing of the second prompt information reaches according to the association, the second prompt information in the second display region corresponding to the second type in the following manner: in the process of displaying the sixth prompt information, when determining that the display timing of the second prompt information reaches according to the association, displaying the second prompt information in a second sub-region in the second display region other than the first sub-region.

Herein, in the process of displaying the first prompt information in the first display region, before displaying the second prompt information of the second type in the second display region, if the terminal device displays sixth prompt information of the second type in the second display region, that is, the terminal device displays the first prompt information in the first display region and the sixth prompt information in the second display region at the same time, when receiving the display instruction for the second prompt information associated with the first prompt information (that is, the display timing of the second prompt information reaches), the terminal device continues to display the sixth prompt information in the second display region, and at the same time displays the second prompt information in a display position of the second display region other than the display position of the sixth prompt information. In this way, while the first prompt information is displayed in the first display region, the second prompt information and the sixth prompt information of the second type are simultaneously displayed in the second display region. The second prompt information and the sixth prompt information are of the same type, but are assigned with different display positions to avoid information overlay. At the same time, this improves the utilization of display resources of the electronic device, the readability of prompt information, and the information prompt efficiency.

For example, the terminal device may display the sixth prompt information of the second type in the first sub-region of the second display region in the following manner: displaying the sixth prompt information of the second type in a first display mode in the first sub-region of the second display region; and correspondingly, the terminal device may display the second prompt information in the second sub-region of the second display region in the following manner: displaying the second prompt information in a second display mode in the second sub-region of the second display region; where the first display mode is different from the second display mode.

Herein, when different prompt information of the same type is displayed in the same display region, the prompt information may be displayed in different display modes to achieve differentiated display of different prompt information of the same type. For example, in the first sub-region of the second display region, the sixth prompt information of the second type is displayed in a first display mode, and in the second sub-region of the second display region, the second prompt information is displayed in a second display mode different from the first display mode, for example, different prompt information of the same type is displayed using different colors, different fonts, special effect elements or not (such as flashing), highlighting, or grayscale, to give players distinct prompt and improve information prompt effectiveness.

For example, the terminal device may display the second prompt information in the second display region corresponding to the second type in the following manner: determining a virtual object in the virtual scene that matches the second prompt information, and using a region where the virtual object is located as the second display region corresponding to the second type; and displaying the second prompt information in the second display region.

Herein, when the second prompt information of the second type is displayed in the second display region, a virtual object matching the second prompt information may be obtained in the virtual scene according to the attribute characteristic (for example, content and a type) of the second prompt information, a region in which the virtual object is located is used as the second display region corresponding to the second type, that is, the virtual object is used as a carrier or a virtual output apparatus of prompt information of the second type, and the second prompt information is output through the virtual object, for example, the type of the second prompt information is announcement, a bulletin board in the virtual scene is obtained, and the second prompt information is displayed on the bulletin board. For another example, when the type of the second prompt information is audio, a virtual speaker device (for example, a loudspeaker or a speaker) in the virtual scene is obtained, and the second prompt information is played through the virtual speaker device. In this way, prompt information is output through a virtual object in the virtual scene. Since the virtual object in the virtual scene can make the player more immersed in the overall scene atmosphere and feel a more realistic virtual world, the prompt is more natural, thereby improving the immersiveness of prompt information.

For example, the terminal device may display the first prompt information in the first display region corresponding to the first type in the following manner: displaying the first prompt information at a first display scrolling speed in the first display region corresponding to the first type; and correspondingly, the terminal device may display the second prompt information in the second display region corresponding to the second type in the following manner: displaying the second prompt information at a second display scrolling speed in the second display region corresponding to the second type; where the first display scrolling speed corresponds to the first type, and the second display scrolling speed corresponds to the second type.

Herein, when displaying corresponding types of prompt information in different display regions, the prompt information may be displayed at different display speeds, for example, text/image scrolling speeds. In actual implementation, the display speed of each type of prompt information may be set according to the type of prompt information, that is, a mapping relationship between a display speed and a type is established in advance. For example, the display speed of an important type of prompt information is lower than the display speed of an unimportant type of prompt information, and the display speed of high-appearance-frequency prompt information is higher than the display speed of low-appearance-frequency prompt information. In this way, when displaying a corresponding type of prompt information, the display speed corresponding to this type is searched based on the preset mapping relationship, and then the corresponding prompt information is displayed at the found display speed. In this way, the display speeds of different types of prompt information are set in a targeted manner, so that the speed of the displayed prompt information is more in line with user needs. For example, unimportant prompt information is displayed quickly, which improves the utilization of display resources. In addition, according to the different types of the first prompt information and the second prompt information, when the first prompt information and the second prompt information are displayed at the same time, specific processing may be performed on the first prompt information so that the display of the second prompt information is more conducive to effective communication.

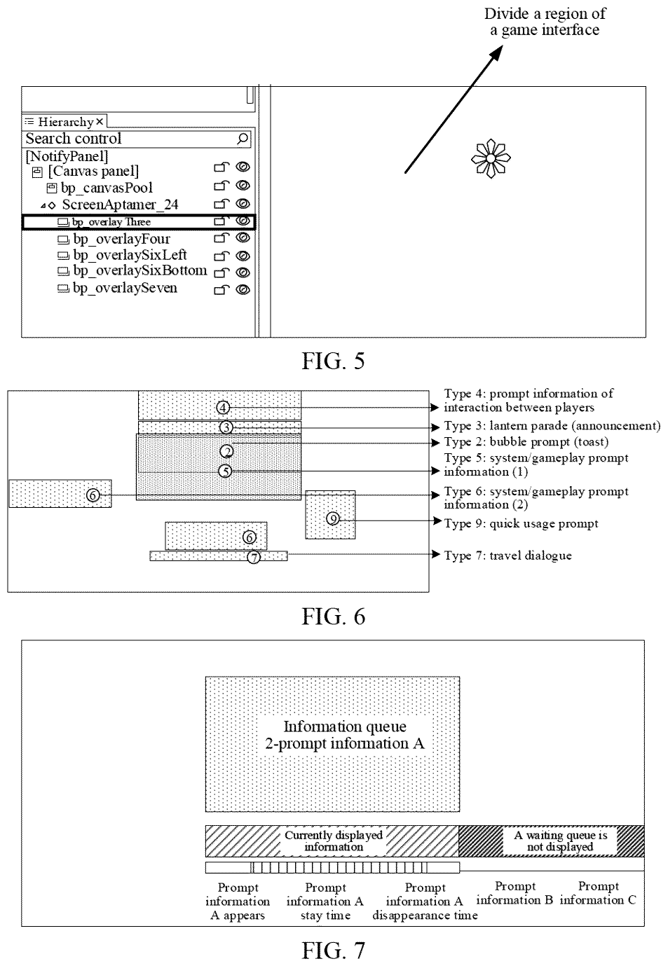

Taking the virtual scene as a game as an example, in the game, the region of the game interface is first divided. FIG. 5 is a schematic diagram of division of a display region according to an aspect of this disclosure. The game interface may be divided into a corresponding number of display regions with a division tool according to the number of types of prompt information. FIG. 6 is a schematic diagram of display region division according to an example of this disclosure. There are 7 types of prompt information. The game interface is divided into 7 display regions. Each display region is used to display a type of prompt information. In addition, a correspondence between each display region and a type of prompt information may be further established based on the attribute characteristic of each type of prompt information (for example, an appearance frequency, a number, important or not, an information length, and a type) and the layout of each divided display region (for example, a location and a size), so that the prompt information displayed in each display region has high readability, achieving prompt information effectiveness.

After establishing the correspondence between each display region and a type of prompt information, an information queue is maintained for each display region. If each type of prompt information is independent of each other, the terminal device also independently controls the prompt information in each display region, that is, corresponding types of prompt information are displayed in different display regions without interference from each other, and the corresponding type of prompt information is displayed according to respective display logic. For example, FIG. 7 is a schematic diagram of display control of prompt information according to this disclosure. It is assumed that an information queue 2 is maintained for a target display region, and the prompt information in the information queue 2 is sorted in descending order of prompt priorities. When the prompt information is displayed in the target display region, the prompt information is sequentially displayed according to the sorting in the information queue 2. For example, the sorting of the prompt information in the information queue 2 is: prompt information A, prompt information B, and prompt information C. The prompt information A, the prompt information B, and the prompt information C are sequentially displayed in this order.

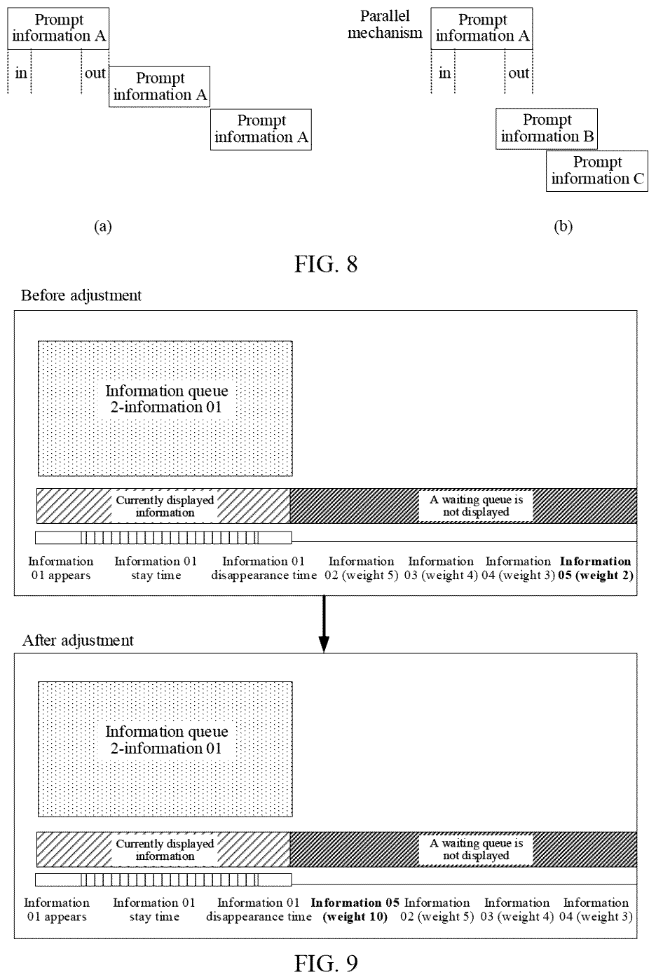

The above method of sequentially displaying prompt information in an order is a serial mechanism. When different prompt information of the same type is displayed in the same display region, a parallel mechanism may also be used. For example, FIG. 8 is a schematic diagram of display control of prompt information according to this disclosure. In (a), in the serial mechanism, prompt information A, prompt information B, and prompt information C in the same display region are sequentially displayed independently without any intersection between the information, that is, one piece of prompt information is displayed at a time in the same display region. In (b), in the parallel mechanism, prompt information A, prompt information B, and prompt information C in the same display region may be displayed with intersection, that is, multiple pieces of prompt information may be displayed simultaneously in the same display region.

For different prompt information in the same information queue, the prompt information is sorted in descending order of prompt priorities of prompt information, and the prompt priority is determined based on the generation time of the prompt information, the prompt weight set for the prompt information, and the like. For example, for a piece of prompt information, when the set prompt weight is larger, the corresponding prompt priority is higher, or when the generation time is earlier, the corresponding prompt priority is higher. When multiple pieces of prompt information have the same prompt weight, the prompt priority of each piece of prompt information is determined according to the generation time.

The prompt priority of the prompt information may be adjusted by adjusting the prompt weight to adjust the order of the prompt information in the information queue. For example, FIG. 9 is a schematic diagram of display control of the prompt information according to this disclosure. Before adjusting the sorting of prompt information in the information queue 2, the prompt information is sorted in descending order of prompt weights as follows: information 01, information 02 (weight 5), information 03 (weight 4), information 04 (weight 3), and information 05 (weight 2). The prompt weight of information 05 is adjusted, for example, the prompt weight is adjusted from 2 to 10. Then, the prompt information in the information queue 2 is re-sorted as: information 01, information 05 (weight 10), information 02 (weight 5), information 03 (weight 4), and information 04 (weight 3). In this way, the prompt information may be sequentially displayed in the target display region according to the new order.

The association between different types of prompt information is usually established during the generation stage of the prompt information. Under normal circumstances, the generation of one piece of prompt information among different pieces of prompt information that are associated is related to the game progress and the display progress of another piece of prompt information. For example, when a level of the target virtual object is a level 1, the first prompt information is displayed in the first display region. As the level of the target virtual object gradually increases, for example, increases to a level 2, the terminal device derives the second prompt information of the second type based on the first prompt information, and establishes association between the first prompt information and the second prompt information.

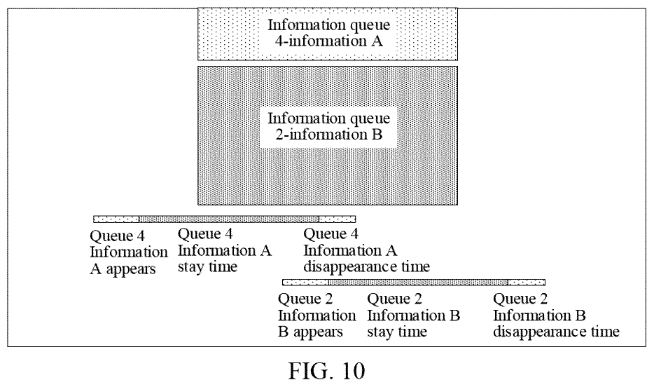

Herein, for the first prompt information and the second prompt information that are associated, the association is configured for indicating the display timing of the second prompt information (that is, relative to the display progress of the first prompt information, a time at which the second prompt information is displayed). For example, FIG. 10 is a schematic diagram of display control of prompt information according to this disclosure. Prompt information A in the information queue 4 corresponding to the first display region is associated with prompt information B in the information queue 2 corresponding to the second display region. The association indicates that when display of the prompt information A is completed in the first display region, the prompt information B starts to be displayed in the second display region. In this case, in the process of displaying the prompt information A, the terminal device detects whether the disappearance time of the prompt information A reaches, and when the disappearance time of the prompt information A reaches, determines that the display timing of the prompt information B reaches. In this case, the display of the prompt information A in the first display region is cancelled, and the prompt information B starts to be displayed in the second display region. In this way, the prompt information B may be displayed in a timely manner, which ensures the display timeliness of the prompt information and improves the user experience. At the same time, the hardware display resources of the terminal device are fully utilized and the utilization rate of the display resources of the terminal device is improved.

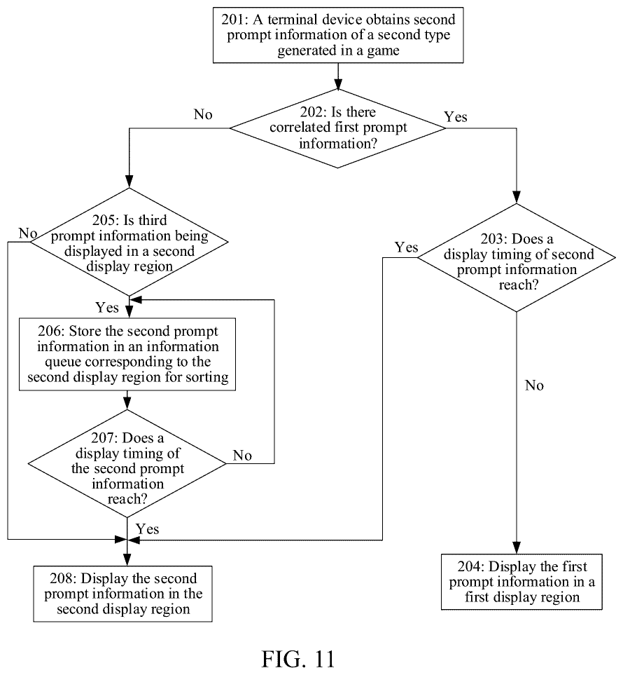

Next, the information prompt method in a virtual scene will continue to be described. FIG. 11 is a schematic flowchart of an information prompt method in a virtual scene according to this disclosure. The method includes:

Operation 201: A terminal device obtains second prompt information of a second type generated in a game.

Operation 202: Determine whether there is first prompt information associated with the second prompt information.

The first prompt information and the second prompt information are of different types, and the type of the first prompt information is a first type. When there is first prompt information associated with the second prompt information, operation 203 is executed. When there is no first prompt information associated with the second prompt information, operation 205 is executed.

Operation 203: Determine whether a display timing of the second prompt information is reached.

As described above, for the first prompt information and the second prompt information that are associated, the association is configured for indicating the display timing of the second prompt information. When it is determined, according to the association, that the display timing of the second prompt information is reached, for example, the display time point of the second prompt information reaches or the time distance from the display time point reaches the preset threshold, operation 208 is executed. When it is determined, according to the association, that the display timing of the second prompt information is not reached, operation 204 is executed.

Operation 204: Display the first prompt information in a first display region.

Before the terminal device obtains the second prompt information, the first prompt information may have been displayed in the first display region. When it is determined, according to the association, that the display timing of the second prompt information has not yet been reached, prompt information displayed in the first display region and the second display region (corresponding to the second type) is independent of each other. For example, if display of the first prompt information is not completed, the first prompt information may continue to be displayed in the first display region. After display of the first prompt information is completed, other prompt information of the same type continues to be displayed in the first display region. A corresponding type of prompt information is displayed in the second display region according to respective display logic.

Operation 205: Determine whether third prompt information is being displayed in the second display region corresponding to the second type.

The second display region is configured for displaying prompt information of the second type, and the type of the third prompt information and the type of the second prompt information are the same, and both are the second type. When the third prompt information of the same type is being displayed in the second display region, operation 206 is executed. Otherwise, operation 207 is executed.

Operation 206: Store the second prompt information in an information queue corresponding to the second display region for sorting.

There may be other to-be-displayed prompt information in the information queue. After the second prompt information is placed in the information queue, the second prompt information and other to-be-displayed prompt information need to be re-sorted, for example, in descending order of prompt priorities of the second prompt information and other prompt information.

Operation 207: Determine whether a display timing of the second prompt information is reached.

Herein, when display of the third prompt information in the first display region is completed, prompt information is sequentially displayed in the second display region in descending order. When it is the turn of the second prompt information, it is determined that the display timing of the second prompt information is reached, and in this case, operation 208 is executed. Otherwise, operation 206 is executed.

Operation 208: Display the second prompt information in the second display region.

In the above manner, the game interface is divided into multiple display regions, and different types of prompt information are displayed in different display regions respectively, which avoids information overlay and improves the readability of the prompt information. Besides, different types of prompt information may be displayed at the same time in the corresponding display regions, which improves information prompt efficiency. Moreover, by adjusting the prompt weight of the prompt information, the display order of the prompt information is adjusted, which improves the display flexibility of the prompt information. In addition, an association is established for different types of prompt information in different display regions. In the process of displaying one type of prompt information, when the display timing of another type of prompt information reaches, the another type of prompt information is immediately displayed in the corresponding display region, thereby ensuring the display timeliness of prompt information and improving user experience.

The following continues to describe an example structure of an information prompt apparatus 465 in a virtual scene implemented as software modules provided by this disclosure. For example, the software modules in the information prompt apparatus 465 in a virtual scene stored in the memory 460 in FIG. 3 may include: a first display module 4651, a second display module 4652, and a third display module 4653.

The first display module 4651 is configured to display a virtual scene interface including at least two display regions, different display regions being configured for displaying different types of prompt information.

The second display module 4652 is configured to display, in response to a display instruction for first prompt information of a first type, the first prompt information in a first display region corresponding to the first type.

The third display module 4653 is configured to: in a process of displaying the first prompt information, display, in response to that second prompt information of a second type exists in the virtual scene a display time point of the second prompt information reaches or a time distance from the display time point reaches a preset threshold, the second prompt information in a second display region corresponding to the second type.

For example, before displaying a virtual scene interface including at least two display regions, the apparatus further includes: an interface division module, configured to: when a number of types of prompt information in a virtual scene is a target number, divide the virtual scene interface into the target number of display regions, where each display region corresponds to one type of prompt information; and according to distribution of the display region and a type of the prompt information, establish a correspondence between each display region and a corresponding type of prompt information.

For example, the apparatus further includes: an association establishment module, configured to: in the process of displaying the first prompt information, obtain a running progress of the virtual scene and a display progress of the first prompt information; and generate the second prompt information according to the running progress and the display progress, and establish an association between the first prompt information and the second prompt information.

For example, before displaying the second prompt information in a second display region corresponding to the second type, the apparatus further includes: a timing determination module, configured to: when the association indicates that display of the second prompt information starts when the display progress of the first prompt information reaches the target progress, in the process of displaying the first prompt information, detect the display progress of the first prompt information; and when the display progress of the first prompt information reaches the target progress, determine that the display timing of the second prompt information reaches.

For example, the apparatus further includes: a fourth display module, configured to: in response to the second prompt information not being associated with the first prompt information, detect whether third prompt information of the second type is displayed in the second display region; and in response to the third prompt information not being displayed in the second display region, display the second prompt information in the second display region.

For example, the apparatus further includes: a fifth display module, configured to: in response to the third prompt information being displayed in the second display region, in the process of displaying the third prompt information, display the second prompt information in the second display region; where display positions of the second prompt information and the third prompt information in the second display region are different.

For example, the apparatus further includes: a sixth display module, configured to: in response to the third prompt information being displayed in the second display region, store the second prompt information in an information queue corresponding to the second display region, where at least one piece of fourth prompt information is also stored in the information queue; obtain prompt priorities corresponding to the second prompt information and the at least one piece of fourth prompt information respectively, and sort the second prompt information and the at least one piece of fourth prompt information in descending order of the prompt priorities; and in response to display of the third prompt information being completed, display, in the second display region, prompt information sorted in front in the information queue.

For example, the apparatus further includes: a priority determination module, configured to: obtain priority parameters of the second prompt information and each of the at least one piece of fourth prompt information; where the priority parameter includes at least one of the following: a generation time of generating the prompt information in the virtual scene and a prompt weight set for the prompt information; and based on the prompt priority parameter, determine the prompt priority of the prompt information.

For example, the sixth display module is further configured to: in response to the third prompt information being displayed in the second display region, compare the prompt priorities of the third prompt information and the second prompt information; and in response to the prompt priority of the third prompt information being higher than the prompt priority of the second prompt information, store the second prompt information in the information queue corresponding to the second display region.

For example, the apparatus further includes: a seventh display module, configured to: in response to the prompt priority of the third prompt information being lower than the prompt priority of the second prompt information, stop displaying the third prompt information in the second display region, and display the second prompt information in the second display region; and in response to display of the second prompt information being completed, continue to display the third prompt information in the second display region.

For example, the apparatus further includes: an eighth display module, configured to: in the process of displaying the first prompt information, display fifth prompt information of the second type in the second display region; correspondingly, the third display module is further configured to: in the process of displaying the fifth prompt information, when determining that the display timing of the second prompt information reaches according to the association, stop displaying the fifth prompt information in the second display region and display the second prompt Information; and the eighth display module is further configured to: in response to display of the second prompt information being completed, continue to display the fifth prompt information in the second display region.

For example, the apparatus further includes: a ninth display module, configured to: in the process of displaying the first prompt information, display sixth prompt information of the second type in a first sub-region of the second display region; correspondingly, the third display module is further configured to: in the process of displaying the sixth prompt information, when determining that the display timing of the second prompt information reaches according to the association, display the second prompt information in a second sub-region in the second display region other than the first sub-region.

For example, the ninth display module is further configured to display the sixth prompt information of the second type in a first display mode in the first sub-region of the second display region; and correspondingly, the third display module is further configured to display the second prompt information in a second display mode in the second sub-region of the second display region; where the first display mode is different from the second display mode.

For example, the third display module is further configured to determine a virtual object in the virtual scene that matches the second prompt information, and use a region where the virtual object is located as the second display region corresponding to the second type; and display the second prompt information in the second display region.

For example, the second display module is further configured to display the first prompt information at a first display speed in the first display region corresponding to the first type; and correspondingly, the third display module is further configured to display the second prompt information at a second display speed in the second display region corresponding to the second type; where the first display speed corresponds to the first type, and the second display speed corresponds to the second type.

An aspect of this disclosure provides a computer program product, including a computer program or a computer executable instruction stored in a computer-readable storage medium. A processor of a terminal device reads the computer executable instruction from the computer-readable storage medium, and the processor executes the computer executable instruction, so that the electronic device performs the information prompt method in a virtual scene.

An aspect of this disclosure provides a computer-readable storage medium storing a computer executable instruction. When the computer executable instruction is executed by a processor, the processor is caused to execute the information prompt method in a virtual scene, for example, the method shown in FIG. 4.

For example, the computer-readable storage medium may be a storage such as a read-only memory (ROM), a random access memory (RAM), an erasable programmable read-only memory (EPROM), an electrically erasable programmable read-only memory (EEPROM), a flash memory, a magnetic surface memory, an optical disc, or a CD-ROM, or may be various devices including one of or any combination of the foregoing memories.

For example, the computer executable instruction may be in the form of programs, software, software modules, scripts, or code written in any form of programming language (including compiled or interpreted languages, or declarative or procedural languages), and may be deployed in any form, for example, deployed as a stand-alone program or as a module, component, subroutine, or other units suitable for usage in a computing environment.

As an example, the computer executable instruction may, but may not necessarily correspond to files in a file system, may be stored as a part of a file that holds other programs or data, for example, stored in one or more scripts stored in a hypertext markup language (HTML) document, stored in a single file dedicated to the program in question, or stored in multiple collaborative files (for example, files that store one or more modules, sub-programs, or code portions).

As an example, the computer executable instruction may be deployed to be executed on one electronic device, or on multiple electronic devices located at one site, or on multiple electronic devices distributed across multiple sites and interconnected by a communication network.

The foregoing descriptions are not intended to limit the protection scope of this disclosure. In the information prompt method in a virtual scene, when outputting the prompt information, the prompt information is displayed in the display region. Output manners of the prompt information may also be increased according to the type of the prompt information. For example, when the prompt information is an audio or a video, the prompt information may be played in the display region through playback, and the playback manner may be adjusted in the playback process. For example, both the first prompt information and the second prompt information are an audio. When the first prompt information and the second prompt information are played at the same time, the first prompt information may be silenced, so that when the first prompt information is played, the playback volume of the first prompt information is controlled to be reduced or even muted, and the playback volume of the second prompt information is normal to highlight the second prompt information. The examples of this disclosure do not limit the output manner of prompt information. Any modifications, equivalent replacements, and improvements made within the spirit and scope of this disclosure are included within the scope of protection of this disclosure.

What is claimed is:

1. An information prompt method in a virtual scene, the method comprising:
displaying, by processing circuitry, a virtual scene interface comprising at least two display regions, each region being configured to display a different type of prompt information, wherein a number of the at least two display regions is based on a number of types of prompt information to be displayed on the virtual scene interface;
displaying first prompt information in a first display region of the at least two display regions corresponding to a first type of prompt information; and
displaying, when a display time point of second prompt information reaches a preset threshold, the second prompt information in a second display region of the at least two display regions corresponding to a second type of prompt information.

2. The method according to claim 1, wherein the method further comprises:
generating the second prompt information according to a running progress of the virtual scene and a display progress of the first prompt information, and
determining an association between the first prompt information and the second prompt information.

3. The method according to claim 2, wherein the method further comprises:
detecting the display progress of the first prompt information; and
determining the display time point of the second prompt information when the display progress of the first prompt information reaches a target progress.

4. The method according to claim 2, wherein the method further comprises:
when the second prompt information is not associated with the first prompt information, detecting whether third prompt information of the second type is displayed in the second display region; and
when the third prompt information is not displayed in the second display region, displaying the second prompt information in the second display region while the third prompt information is displayed.

5. The method according to claim 4, wherein the method further comprises:
displaying the third prompt information in the second display region,
wherein the second prompt information and the third prompt information are displayed in different locations of the second display region.

6. The method according to claim 5, wherein the method further comprises:
obtaining priority parameters corresponding to the prompt information;
wherein the priority parameter includes at least one of: a generation time of the prompt information and a prompt weight set for the prompt information; and
determining the prompt priorities corresponding to each of the prompt information.

7. The method according to claim 6, wherein the method further comprises:
comparing the prompt priorities of the third prompt information and the second prompt information; and
based on the prompt priority of the third prompt information being higher than the prompt priority of the second prompt information, stopping the displaying of the second prompt information in the second display region, and displaying the third prompt information in the second display region.

8. The method according to claim 7, wherein the method further comprises:
based on the prompt priority of the third prompt information being lower than the prompt priority of the second prompt information, stopping the displaying of the third prompt information in the second display region, and displaying the second prompt information in the second display region; and
based on display of the second prompt information being completed, continuing to display the third prompt information in the second display region.

9. The method according to claim 1, wherein the method further comprises:
determining a virtual object in the virtual scene that matches the second prompt information; and
displaying the second prompt information in the second display region, wherein the second display region is a region in which the virtual object is located.

10. The method according to claim 1, wherein the method further comprises:
displaying the first prompt information at a first display scrolling speed in the first display region; and
displaying the second prompt information at a second display scrolling speed in the second display region;
wherein the first display scrolling speed corresponds to the first type, and the second display scrolling speed corresponds to the second type.

11. An apparatus of prompt information in a virtual scene, the apparatus comprising:
processing circuitry configured to:
display a virtual scene interface comprising at least two display regions, each region being configured to display a different type of prompt information, wherein a number of the at least two display regions is based on a number of types of prompt information to be displayed on the virtual scene interface;
display first prompt information in a first display region of the at least two display regions corresponding to a first type of prompt information; and
display second prompt information in a second display region of the at least two display regions corresponding to a second type of prompt information when a display time point of the second prompt information reaches a preset threshold.

12. The apparatus according to claim 11, wherein the processing circuitry configured to:
generate the second prompt information according to a running progress of the virtual scene and a display progress of the first prompt information, and
determine an association between the first prompt information and the second prompt information.

13. The apparatus according to claim 12, wherein the processing circuitry configured to:
detect the display progress of the first prompt information; and
determine the display time point of the second prompt information when the display progress of the first prompt information reaches a target progress.

14. The apparatus according to claim 12, wherein the processing circuitry configured to:
detect whether third prompt information of the second type is displayed in the second display region when the second prompt information is not associated with the first prompt information; and
display the second prompt information in the second display region while the third prompt information is displayed when the third prompt information is not displayed in the second display region.

15. The apparatus according to claim 14, wherein the processing circuitry configured to:
display the third prompt information in the second display region, wherein the second prompt information and the third prompt information are displayed in different locations of the second display region.

16. A non-transitory computer-readable storage medium, storing instructions which when executed by a processor cause the processor to perform:
displaying a virtual scene interface comprising at least two display regions, each region being configured to display a different type of prompt information, wherein a number of the at least two display regions is based on a number of types of prompt information;
displaying a first prompt information in a first display region of the at least two display regions corresponding to a first type of prompt information; and
displaying a second prompt information in a second display region of the at least two display regions corresponding to a second type of prompt information when a display time point of the second prompt information reaches a preset threshold.

17. The non-transitory computer-readable storage medium according to claim 16, wherein the instructions when executed by the processor further cause the processor to perform:
generating the second prompt information according to a running progress of the virtual scene and a display progress of the first prompt information, and
determining an association between the first prompt information and the second prompt information.

18. The non-transitory computer-readable storage medium according to claim 17, wherein the instructions when executed by the processor further cause the processor to perform:
detecting the display progress of the first prompt information; and
determining the display time point of the second prompt information when the display progress of the first prompt information reaches a target progress.

19. The non-transitory computer-readable storage medium according to claim 17, wherein the instructions when executed by the processor further cause the processor to perform:
detecting whether third prompt information of the second type is displayed in the second display region when the second prompt information not being associated with the first prompt information; and
displaying the second prompt information in the second display region while the third prompt information is displayed when the third prompt information is not displayed in the second display region.

20. The non-transitory computer-readable storage medium according to claim 19, wherein the instructions when executed by the processor further cause the processor to perform:
displaying the third prompt information in the second display region, wherein the second prompt information and the third prompt information are displayed in different locations of the second display region.
